(19) United States
(12) Patent Application Publication
(10) Pub. No.: US 2024/0232209 A9
(43) Pub. Date: Jul. 11, 2024

(54) ENTITY SELECTION AND RANKING USING DISTRIBUTION SAMPLING

(71) Applicant: Microsoft Technology Licensing, LLC, Redmond, WA (US)

(72) Inventors: Liyan Fang, Sunnyvale, CA (US); Andrew O. Hatch, Berkeley, CA (US); Keqing Liang, Cupertino, CA (US); Yafei Wei, Sunnyvale, CA (US); Ankan Saha, San Francisco, CA (US)

(21) Appl. No.: 18/048,428

(22) Filed: Oct. 20, 2022

(51) Int. Cl. G06F 16/2457; G06N 20/00

(52) U.S. Cl. CPC G06F 16/24578; G06N 20/00

(57) ABSTRACT

Embodiments of the disclosed technologies include generating a reward score for an entity. A rate distribution is determined using the reward score and a number of times the entity has been selected for ranking. A sampled rate value is generated by sampling the rate distribution. A probability score is generated for a pair of the entity and a user based on the sampled rate value. A probability distribution is determined using the probability score. A sampled probability value is generated by sampling the probability distribution. A machine learning model is trained using the sampled probability value.

### TECHNICAL FIELD

The present disclosure generally relates to machine learning models, and more specifically, relates to generating training data for machine learning models that perform ranking.

### BACKGROUND ART

Machine learning is a category of artificial intelligence. In machine learning, a model is defined by a machine learning algorithm. A machine learning algorithm is a mathematical and/or logical expression of a relationship between inputs to and outputs of the machine learning model. The model is trained by applying the machine learning algorithm to input data. A trained model can be applied to new instances of input data to generate model output. Machine learning model output can include a prediction, a score, or an inference, in response to a new instance of input data. Application systems can use the output of trained machine learning models to determine downstream execution decisions, such as decisions regarding various user interface functionality.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system 100 that includes an entity selection component 150 and an entity ranking component 160 in accordance with some embodiments of the present disclosure.

FIG. 2 is a block diagram of an exemplary computing system 200 that includes an entity selection component 150 and an entity ranking component 160 in accordance with some embodiments of the present disclosure.

FIG. 3 is a block diagram of an exemplary computing system 300 that includes an entity selection component 150 and an entity ranking component 160 in accordance with some embodiments of the present disclosure.

FIG. 4 is a flow diagram of an example method 400 to select and rank entities using distribution sampling in accordance with some embodiments of the present disclosure.

FIG. 5 is a flow diagram of an example method 500 to select and rank entities using distribution sampling in accordance with some embodiments of the present disclosure.

FIG. 6 is a block diagram of an example computer system in which embodiments of the present disclosure can operate.

### DETAILED DESCRIPTION

Aspects of the present disclosure are directed to entity selection and ranking using distribution sampling. The disclosed distribution generation and sampling methods are useful for training and/or operating machine learning models, including machine learning models that are used to rank entities (“ranking models”).

Machine learning models are based on data sets. In many cases, data sets are processed in order to create the inputs to which a machine learning model is applied. Entity selection and ranking are examples of such processing. In social networking applications, entities can include a page with which a user of the social networking application can interact. For example, an entity could be a person, a group of people, an organization, a job posting, etc. It can be useful to display these entities to users of the social networking applications so that they can interact with them. These entities, therefore, may be selected and ranked in order to be displayed. Entity selection serves as a prefilter for inputs to a ranking machine learning model. Additionally, entity ranking can change ranking machine learning model inputs to boost entities with certain characteristics.

The traditional way to select and rank entities results in entities with lower levels of interactions not featuring prominently even if the entities are high quality. For example, previous methods rank entities higher when they have higher levels of interactions and rank entities lower when they have lower levels of interactions. An example of a high-quality entity is a group that posts very informative subject matter that a lot of users would interact with if made available to them. If such an entity does not have high levels of interaction to begin with, however, it will not feature prominently or be suggested to other users, preventing such an entity from gaining traction. Entities with lower levels of interactions rely on less data and are difficult to accurately rank. These entities are therefore shown to users less frequently, preventing them from receiving more interactions. This cycle further prevents the entities from being selected or highly ranked in the future.

Aspects of the present disclosure address the above and other deficiencies by using rate distributions and probability distributions to adjust the selection and ranking of entities, allowing entities with lower numbers of followers to feature more prominently in entity selection and ranking. The disclosed approaches generate and sample rate distributions and probability distributions to expand the range of values to which the entity selecting and ranking operations are applied. As such, the disclosed approaches allow entities with historically lower levels of interactions more opportunities to feature prominently and receive more interactions in the future. These improvements to the entity selection and ranking processes improve the quality of data used by the machine learning model, and therefore improve the likelihood that high quality entities will be selected and highly ranked by the machine learning model in the future.

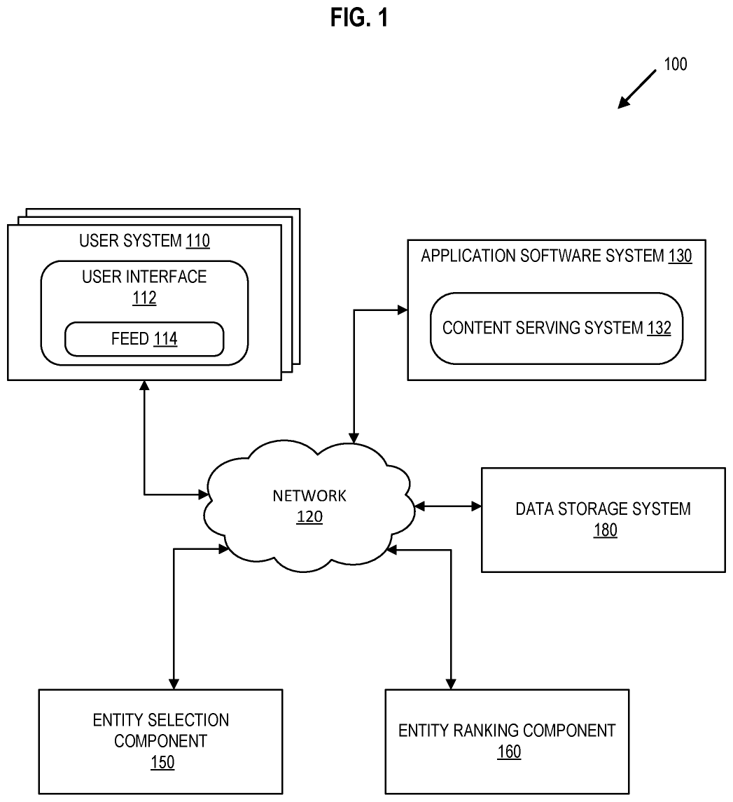

In the embodiment of FIG. 1, computing system 100 includes a user system 110, a network 120, an application software system 130, a data store 140, an entity selection component 150, and an entity ranking component 160.

User system 110 includes at least one computing device, such as a personal computing device, a server, a mobile computing device, or a smart appliance. User system 110 includes at least one software application, including a user interface 112, installed on or accessible by a network to a computing device. For example, user interface 112 can be or include a front-end portion of application software system 130.

User interface 112 is any type of user interface as described above. User interface 112 can be used to input search queries and view or otherwise perceive output that includes data produced by application software system 130. For example, user interface 112 can include a graphical user interface and/or a conversational voice/speech interface that includes a mechanism for entering a search query and viewing query results and/or other digital content. Examples of user interface 112 include web browsers, command line interfaces, and mobile apps. User interface 112 as used herein can include application programming interfaces (APIs).

Data store 140 can reside on at least one persistent and/or volatile storage device that can reside within the same local network as at least one other device of computing system 100 and/or in a network that is remote relative to at least one other device of computing system 100. Thus, although depicted as being included in computing system 100, portions of data store 140 can be part of computing system 100 or accessed by computing system 100 over a network, such as network 120.

Application software system 130 is any type of application software system that includes or utilizes functionality provided by entity selection component 150. Examples of application software system 130 include but are not limited to connections network software, such as social media platforms, and systems that are or are not be based on connections network software, such as general-purpose search engines, job search software, recruiter search software, sales assistance software, advertising software, learning and education software, or any combination of any of the foregoing.

While not specifically shown, it should be understood that any of user system 110, application software system 130, data store 140, entity selection component 150, and entity ranking component 160 includes an interface embodied as computer programming code stored in computer memory that when executed causes a computing device to enable bidirectional communication with any other of user system 110, application software system 130, data store 140, entity selection component 150, and entity ranking component 160 using a communicative coupling mechanism. Examples of communicative coupling mechanisms include network interfaces, inter-process communication (IPC) interfaces and application program interfaces (APIs).

A client portion of application software system 130 can operate in user system 110, for example as a plugin or widget in a graphical user interface of a software application or as a web browser executing user interface 112. In an embodiment, a web browser can transmit an HTTP request over a network (e.g., the Internet) in response to user input that is received through a user interface provided by the web application and displayed through the web browser. A server running application software system 130 and/or a server portion of application software system 130 can receive the input, perform at least one operation using the input, and return output using an HTTP response that the web browser receives and processes.

Each of user system 110, application software system 130, data store 140, entity selection component 150, and entity ranking component 160 is implemented using at least one computing device that is communicatively coupled to electronic communications network 120. Any of user system 110, application software system 130, data store 140, entity selection component 150, and entity ranking component 160 can be bidirectionally communicatively coupled by network 120. User system 110 as well as one or more different user systems (not shown) can be bidirectionally communicatively coupled to application software system 130.

A typical user of user system 110 can be an administrator or end user of application software system 130, entity selection component 150, and/or entity ranking component 160. User system 110 is configured to communicate bidirectionally with any of application software system 130, data store 140, entity selection component 150, and/or entity ranking component 160 over network 120.

The features and functionality of user system 110, application software system 130, data store 140, entity selection component 150, and entity ranking component 160 are implemented using computer software, hardware, or software and hardware, and can include combinations of automated functionality, data structures, and digital data, which are represented schematically in the figures. User system 110, application software system 130, data store 140, entity selection component 150, and entity ranking component 160 are shown as separate elements in FIG. 1 for ease of discussion but the illustration is not meant to imply that separation of these elements is required. The illustrated systems, services, and data stores (or their functionality) can be divided over any number of physical systems, including a single physical computer system, and can communicate with each other in any appropriate manner

Network 120 can be implemented on any medium or mechanism that provides for the exchange of data, signals, and/or instructions between the various components of computing system 100. Examples of network 120 include, without limitation, a Local Area Network (LAN), a Wide Area Network (WAN), an Ethernet network or the Internet, or at least one terrestrial, satellite or wireless link, or a combination of any number of different networks and/or communication links.

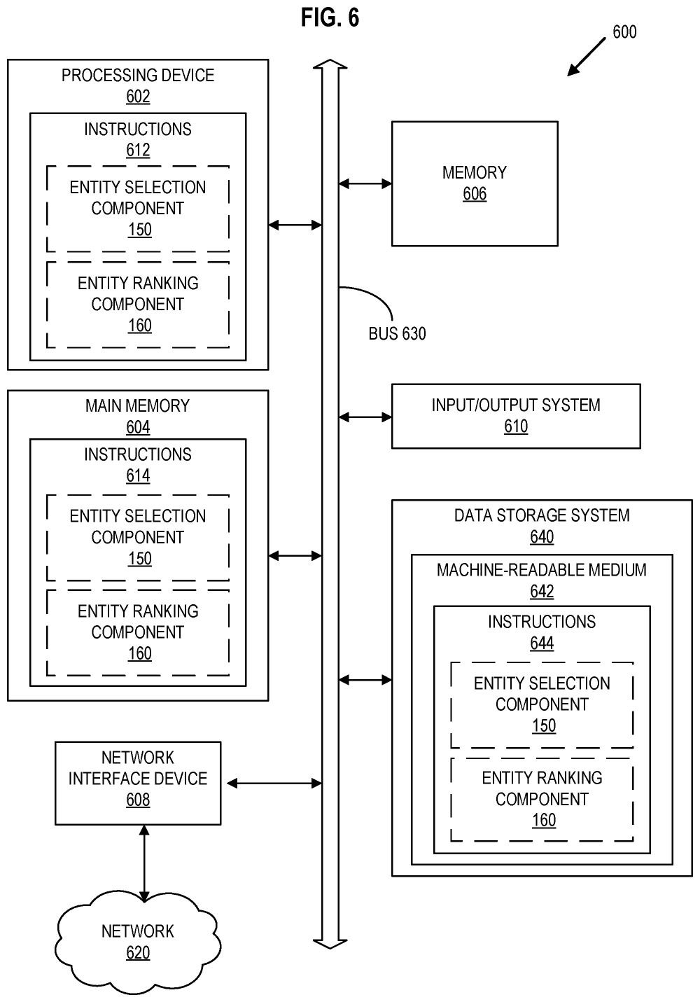

The computing system 110 includes an entity selection component 150 that can generate observed rewards for the entities in a master set of entities, generate rate distributions using the observed rewards, sample the generated rate distributions, and select entities in the master set of entities using the generated rate distributions. In some embodiments, the application software system 130 includes at least a portion of the entity selection component 150. As shown in FIG. 6, the entity selection component 150 can be implemented as instructions stored in a memory, and a processing device 602 can be configured to execute the instructions stored in the memory to perform the operations described herein.

The computing system 110 includes an entity ranking component 160 that can generate probability distributions and sample the probability distributions. In some embodiments, the application software system 130 includes at least a portion of the entity ranking component 160. As shown in FIG. 6, the entity ranking component 160 can be implemented as instructions stored in a memory, and a processing device 602 can be configured to execute the instructions stored in the memory to perform the operations described herein.

The disclosed technologies can be described with reference to an example use case of ranking entities for a machine learning model used to determine downstream behavior of an application software system; for example, a social graph application such as a professional social network application. The disclosed technologies are not limited to social graph applications but can be used to perform entity ranking more generally. The disclosed technologies can be used by many different types of network-based applications in which entity ranking is useful.

Further details with regards to the operations of the entity selection component 150 and the entity ranking component 160 are described below.

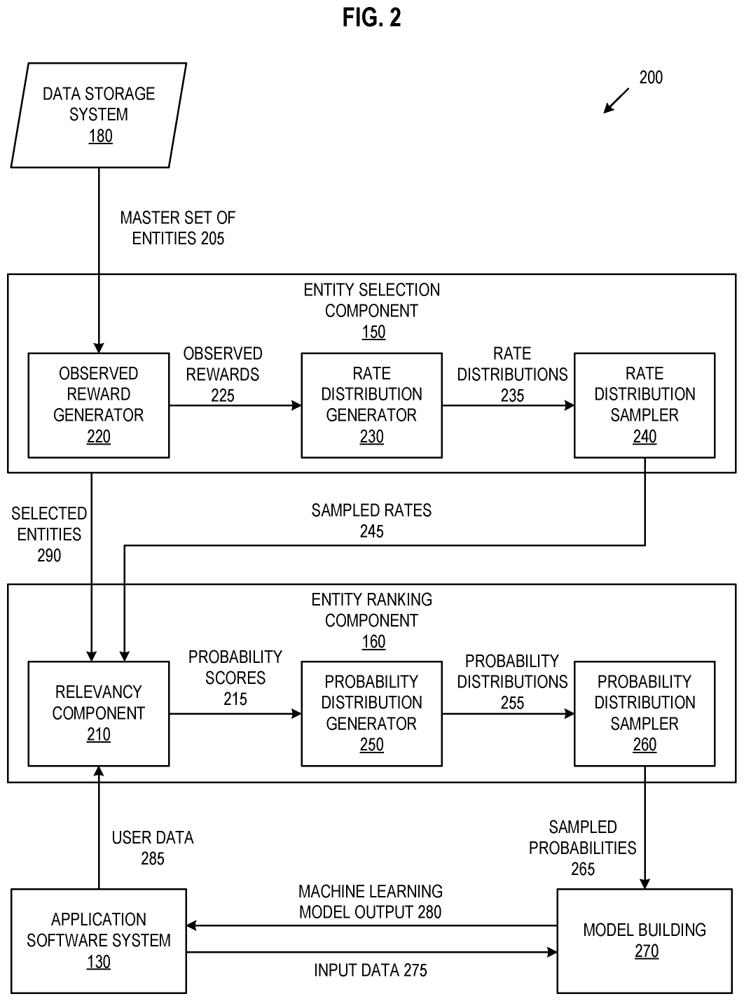

FIG. 2 is a block diagram of an exemplary computing system 200 that includes an entity selection component 150 and an entity ranking component 160 in accordance with some embodiments of the present disclosure. Exemplary computing system 200 also includes data storage system 180, application software system 130, and model building 270.

Data storage system 180 sends master set of entities 205 observed reward generator 220. For example, master set of entities 205 is a set of entities and their associated identifiers, characteristics, or attributes. Each of the entities can be a person, a company, a group, a job listing, and other similar entities with profiles or other information stored in data storage system 180 and accessible through application software system 130. In some embodiments, master set of entities 205 is the output of a machine learning model trained to select entities. In some embodiments, master set of entities 205 is a subset of entities that is filtered based on threshold criteria. For example, master set of entities 205 is a set of entities with followers below a threshold number, such as 500 followers.

Observed reward generator 220 receives master set of entities 205 and determines observed rewards 225. In some embodiments, each of the entities in master set of entities 205 has multiple observed rewards. In some embodiments, observed rewards 225 are based on user attributes of a user associated with user data 285. These observed rewards may alternatively be referred to as observed attribute rewards. User data 285 includes a user's profile along with their interests, identifiers, characteristics, and attributes. Attributes may include, for example, industry, location, position, associated company, skills, job function, job seeker identification, entities following, entities followed, or any combination of any of the foregoing and/or other user attributes. In such embodiments, therefore, observed rewards 225 includes a number of users with a user attribute that follow an entity of master set of entities 205. In such embodiments, observed rewards 225 include observed interactions between each entity of the master set of entities 205 and users of application software system 130. For example, observed rewards is the number of times that a user in a certain industry has followed an entity of the master set of entities 205.

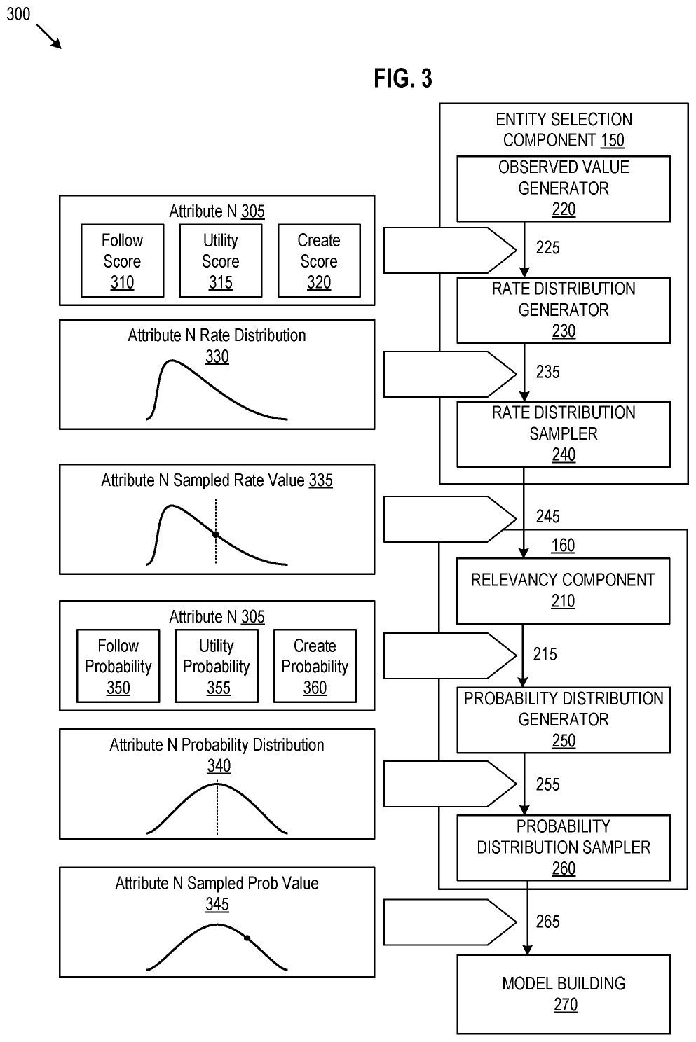

In some embodiments, observed rewards 225 includes, for each user attribute, a weighted combination of a follow score, a utility score, and a create score. Follow score is an observed follow count of an entity of master set of entities 205. Utility score 315 is an observed count of the number of post-follow responses the entity has received from users. For example, a post-follow response may include any action that a user initiates with an entity that the user has followed. These post-follow responses may include, but are not limited to follows, likes, messages, shares, and comments. Create score measures changes in content posted by the entity using data from entities who have been followed by users, where the users perform a post-follow response. For example, a change in content for an entity in response to a post-follow response may be a reply to the user's comment or a change in the frequency of content posted or in the content itself. In some embodiments, the create measures user engagement for the entity. In some embodiments, observed reward generator 220 applies weights to each of the scores (e.g., the follow score, the utility score, and the create score are each weighted separately) based on the use case. For example, in use cases that are focused on improving representation of entities based on the follow score, a higher weight is placed on the follow score and lower weights are applied to the utility score and the create score, respectively. In other use cases, the utility score and/or the create score can be weighted more highly than the follow score. Further details with regards to the operations of observed reward generator 220 are described below, particularly with reference to FIG. 3. Observed reward generator 220 sends observed rewards 225 to rate distribution generator 230.

Rate distribution generator 230 receives observed rewards 225 and determines rate distributions 235. For example, rate distribution generator 230 calculates a probability distribution for each user attribute using observed rewards 225. In some embodiments, rate distribution generator 230 uses the observed reward divided by the number of selections to estimate the mean value of the rate distribution. In some embodiments, the number of selection times is used as a scaling factor to determine the variance of rate distributions 235. The number of selection times is a number of times that an entity of master set of entities 205 has been selected by entity selection component 150 or similar component. Additionally, using the number of selections for the rate distribution causes entities that have been selected fewer times to have a wider distribution and therefore an increased possibility of being selected than they otherwise would have. In some embodiments, the number of selection times is the number of times the entity has been selected by entity selection component 150 or a similar component for display based on a specific user attribute. For example, the more a certain entity is selected to be displayed to users because of the industry the entity belongs to, the less likely the entity will be selected for future users based on its industry. This allows entities that are selected less frequently to feature more prominently in entity selection than they otherwise would. In some embodiments, rate distributions 235 follow a gamma distribution with gamma parameters based on observed rewards 225 and number of selection times. Rate distribution generator 230 sends rate distributions 235 to rate distribution sampler 240.

Rate distribution sampler 240 receives rate distributions 225 and determines sampled rates 245. For example, rate distribution sampler 240 randomly samples rate distributions 235 to determine sampled rates 245. Rate distribution sampler 240 sends sampled rates 245 to relevancy component 210. User data 285 can include identifiers, characteristics, or attributes associated with a user of application software system 130.

In some embodiments, entity selection component 150 generates selected entities 290 from master set of entities 205 using sampled rates 245. For example, entity selection component 150 generates selected entities 290 for entities with sampled rates 245 that satisfy a threshold value, such as a sample rate threshold. In some embodiments, entity selection component 150 generates selected entities 290 from master set of entities 205 for a predetermined number of entities with the highest sampled rates of sampled rates 245. The sample rate threshold is determined based on the requirements and/or design of the particular implementation. For example, application software system 130 may have a predetermined number of selection slots and sample rate threshold is based on a number of selection slots.

Relevancy component 210 receives sampled rates 245 from rate distribution sampler 240 and receives selected entities 290 from entity selection component 150. Relevancy component 210 also receives user data 285 from application software system 130. As mentioned above, user data 285 includes a user's profile along with their interests, identifiers, characteristics, and attributes. Attributes may include, for example, industry, location, position, associated company, skills, job function, job seeker identification, entities following, entities followed, or any combination of any of the foregoing and/or other user attributes. Relevancy component 210 generates probability scores 215 for each of selected entities 290 based on sampled rates 245 and user data 285. In some embodiments, relevancy component 210 uses artificial intelligence or machine learning models to generate probability scores for each entity of selected entities 290 using user data 285. The probability scores 215 are estimates of probabilities of certain actions concerning the user and the entity. For example, probability scores 215 may include a follow probability which is an estimate of the probability that a user will follow the entity. In some embodiments, probability scores 215 also includes a utility probability which is an estimate of the probability that a user will interact (i.e., like a post, share a post, comment, etc.) with an entity after following the entity. In some embodiments, probability scores 215 also includes a create probability which is an estimate of the probability that an entity will change its content based on the user's post-follow interaction. For example, create probability may be a probability that the entity will post more frequently or change the content posted based on the user's comment on the entities post.

Probability distribution generator 250 receives sampled rates 245 and determines probability distributions 255. For example, probability distribution generator 250 uses sampled rates 245, a scaling factor, and a follower number to generate a probability distribution around each of the sampled rates 245. The mean of the probability distribution is based on the sampled rate and the variance is based on the follower number. In some embodiments, the more followers, the smaller the variance such that entities with more followers have a less varied probability distribution. In some embodiments, probability distribution generator 250 also uses a scaling factor to determine the variance. For example, the scaling factor can be altered to change the variance even for the same follower number. The probability distribution allows for a controllable degree of randomness in the candidate ranking system. For example, because the ranking is based on a sampled distribution, two instances with the same inputs may produce different rankings, allowing entities to rank higher than they would in a system that does not use these distributions. Additionally, using the number of followers for the probability distribution causes entities with fewer followers to have a wider distribution and therefore an increased possibility of ranking higher than they otherwise would have. Probability distribution generator 250 sends probability distributions 255 to probability distribution sampler 260.

Probability distribution sampler 260 receives probability distributions 255 and determines sampled probabilities 265. For example, probability distribution sampler 260 randomly samples probability distributions 255 to determine sampled probabilities 265. Probability distribution sampler 260 sends sampled probabilities 265 to model building 270. In some embodiments, probability distribution sampler 260 uses a Thompson sampling method to generate sampled probabilities 265 from probability distributions 255. Further details with regards to the operations of probability distribution sampler 260 are described below, particularly with reference to FIG. 3.

Probability distribution sampler 260 sends sampled probabilities 265 to model building 270. In some embodiments, probability distribution sampler 260 only sends sampled probabilities 265 that exceed a probability sample threshold value to model building 270 and does not send sampled probabilities 265 that do not exceed the probability sample threshold value to model building 270. For example, the probability sample threshold value may be determined for a specific user case or for a specific user. The probability sample threshold value acts as a filter to prevent entities that the user is not likely to interact with from featuring in the ranking. In some embodiments, when executing a trained machine learning model, application software system 130 sends input data 275 to model building 270. Input data 275 can include additional data relating to the user or the entities. For example, input data 275 may include user data 285. Model building 270 builds a ranking machine learning model using sampled probabilities 265. In some embodiments, model building 270 executes the trained ranking machine learning model using sampled probabilities 265 and input data 275. For example, model building 270 ranks the entities associated with sampled probabilities 265 using input data 275. In some embodiments, model building 270 generates a machine learning model output 280 based on sampled probabilities 265 and input data 275 and sends machine learning model output 280 to application software system 130.

Machine learning model output 280 is a ranked list of the entities based on their respective sampled probabilities 265. In some embodiments, model building 270 sends machine learning model output 280 to application software system 130 which uses machine learning model output 280 to determine entities to display to a user of application software system 130. In other embodiments, application software system 130 alters machine learning model output 280 and send the result to another component for further modification or display.

FIG. 3 is a block diagram of an exemplary computing system 300 that includes an entity selection component 150 and an entity ranking component 160 in accordance with some embodiments of the present disclosure. Observed reward generator 220 determines observed rewards 225 for a particular entity of master set of entities 205 and a particular attribute N, where N is a positive integer. In the illustrated embodiment, the observed rewards 225 include follow score 310, utility score 315, and create score 320 for the particular attribute N 305. Although only one attribute is depicted, multiple attributes may be included in observed rewards 225. Similarly, although scores for follow, utility, and create are depicted, only one or two of these (e.g., only follow or only follow and utility) may be used. Attribute N 305 is an attribute of a particular user associated with user data (such as user data 285 of FIG. 2. For example, attributes of a user include industry, location, position, associated company, skills, job function, job seeker identification, entities following, entities followed, or any combination of any of the foregoing and/or other user attributes.

Follow score 310, utility score 315, and create score 320 are scores associated with a relevant entity of relevant entities 215. Follow score 310 is an observed follow count of the relevant entity for followers with attribute N 305. In some embodiments, follow score 310 is determined for a given period of time. For example, follow score 310 is the number of users with attribute N 305 that have followed the relevant entity within the past six months. Utility score 315 is an observed count of the number of post-follow responses the relevant entity has received from users with attribute N 305. For example, a post-follow response may include any action that a user initiates with an entity that the user has followed. These post-follow responses may include, but are not limited to follows, likes, messages, shares, and comments. In some embodiments, utility score 315 is determined for a given period of time. For example, utility score 315 is the number of post-follow responses from users with attribute N 305 that the relevant entity has received within the past six months. Create score 320 measures changes in content posted by the entity based on outputs of machine learning models using data from entities who have been followed by users with attribute N 305, where the users perform a post-follow response. For example, a change in content for an entity in response to a post-follow response may be a reply to the user's comment or a change in the frequency of content posted or in the content itself. In some embodiments, attribute N 305 for a given entity has a number of selection times, where the number of selection times is a number of times the entity has been selected in the past for attribute N 305.

Rate distribution generator 230 uses observed rewards 225 to generate rate distributions 235 which includes attribute N rate distribution 330. As explained with reference to FIG. 2, rate distributions are generated based on the weighted combination of follow, utility, and create scores. For example, rate distribution generator 230 generates attribute N rate distribution 330 with a mean of the weighted combination of follow score 310, utility score 315, and create score 320 and a variance based on the number of selection times. In some embodiments, rate distributions 235 are gamma distributions with gamma distribution parameters based on the weighted combination of scores 310, 315, and 320 and the number of selection times. For example, rate distribution generator 230 generates a rate distribution with less variance (more narrowly distributed) for entities that have been selected many times. Entities that are less frequently selected, therefore, have larger rate distributions.

Rate distribution sampler 240 samples rate distributions 235 to generate sampled rates 245 including attribute N sampled rate value 335. For example, rate distribution sampler 240 samples attribute N rate distribution 330 according to its distribution pattern to generate attribute N sampled rate value 335.

Relevancy component 210 generates probability scores 215 including follow probability 350, utility probability 355, and create probability 360 based on the sampled rates 245 and user data, such as user data 285 of FIG. 2. In some embodiments, relevancy component 210 selects entities from the master set of entities using sampled rates 245 as explained in detail with reference to FIG. 2. Although only one attribute is depicted, multiple attributes may be included in probability scores 215. Similarly, although probabilities for follow, utility, and create are depicted, only one or two of these (e.g., only follow or only follow and utility) may be used. Relevancy component 210 generates follow probability 350, utility probability 355, and create probability 360 for selected entities.

Follow probability 350 is the estimated probability that the user associated with the user data will follow an entity based on attribute N 305. For example, if attribute N is an industry, follow probability 350 is the estimated probability that the user associated with user data 285 will follow an entity based on the user's industry and the sampled rates representing others in the same industry who have followed the entity.

Utility probability 355 is the estimated probability that the user associated with the user data will perform a downstream action with an entity after following the entity based on attribute N 305. Using the above example of attribute N representing an industry, utility probability 355 is the estimated probability that the user associated with user data 285 will perform a downstream action, such as liking a post of an entity after following the entity based on the user's industry and the sampled rates representing others in the same industry who have interacted with the entity after following.

Create probability 360 is the estimated probability of a change in content posted by the entity in response to post follow responses by the user associated with user data 285. Keeping with the same industry example above, create probability 360 is the estimated probability that the entity will change the content it posts in response to the user associated with user data 285 performing a downstream action, such as liking a post of the entity based on the user's industry and the sampled rates representing other content changes in response to others in the same industry who have interacted with the entity after following.

Probability distribution generator 250 uses probability scores 215 to generate probability distributions 255 including attribute N probability distribution 340. For example, attribute N probability distribution 340 is a distribution with a mean value of the weighted combination of attribute N follow probability 350, utility probability 355, and create probability 360. In some embodiments, probability distribution generator 250 generates attribute N probability distribution 340 based on a follower number for the entity. For example, probability distribution generator 250 uses a follower number of the entity as well as a scaling factor to determine the variance of attribute N probability distribution 340. Entities with a larger follower number have probability distributions with less variance. In some embodiments, a scaling factor is used to adjust how much the variance is changed based on the follower number. For example, the scaling factor can be adjusted so that the variance of the probability distribution changes more in response to the same difference in follower number. In some embodiments, attribute N probability distribution 340 is a beta distribution with beta distribution parameters based on attribute N sampled rate value 335, follower number of the relevant entity, and the scaling factor.

Probability distribution sampler 260 uses probability distributions 255 to generate sampled probabilities 265 including attribute N sampled probability value 345. For example, probability distribution sampler 260 samples attribute N probability distribution 340 to generate attribute N sample probability value 345. In some embodiments, probability distribution sampler 260 uses a Thompson sampling method on the predicted probability distributions to generate sampled probabilities 265. For example, the mean value (μ_{v,e}) of attribute N probability distribution 340 is calculated according to μ_{v,e}=follow_{θ}(e|v), where e is the relevant entity, v is the user associated with user data 285, and follow_{θ} is the predicted weighted combination of scores based on attribute N sampled rate value 335. In some embodiments, the predicted weighted combination of scores is taken from observed rewards 225 rather than sampled rates 245. In some embodiments, follow_{θ} is approximated based on the following equation:

$$\\ {follow}_{θ} ( e \vert v ) \sim B ( {γ}_{0} * \#followers ( e ) , {γ}_{0} * \#followers ( e ) * \frac{1 - {μ}_{v , e}}{{μ}_{v , e}} ) ,$$

where B is the beta distribution and γ₀ is the scaling factor. The variance (α_{v,e}) of attribute N probability distribution 340 is calculated according to

$$\\ \frac{{μ}_{v , e}^{{}^{} 2} ( 1 - {μ}_{v , e} )}{{α}_{v , e}} ,$$

where α_{v,e}=γ₀* #followers(e).

Probability distribution sampler 260 sends sampled probabilities 265 to model building 270 for use in training or executing a ranking machine learning model. In some embodiments, probability distribution sampler 260 only sends sampled probabilities 265 that exceed a probability sample threshold value. For example, the probability sample threshold is a percentage such that probability distribution sampler 240 only samples probabilities 265 with a weighted combination of the probabilities greater than the threshold percentage. In some embodiments, model building 270 also receives input data from an application software system, such as application software system 130 of FIGS. 1 and 2. Model building 270 builds and executes a ranking machine learning model using sampled probabilities 265. In some embodiments, model building 270 includes a machine learning model and a ranking system to rank sampled probabilities 265.

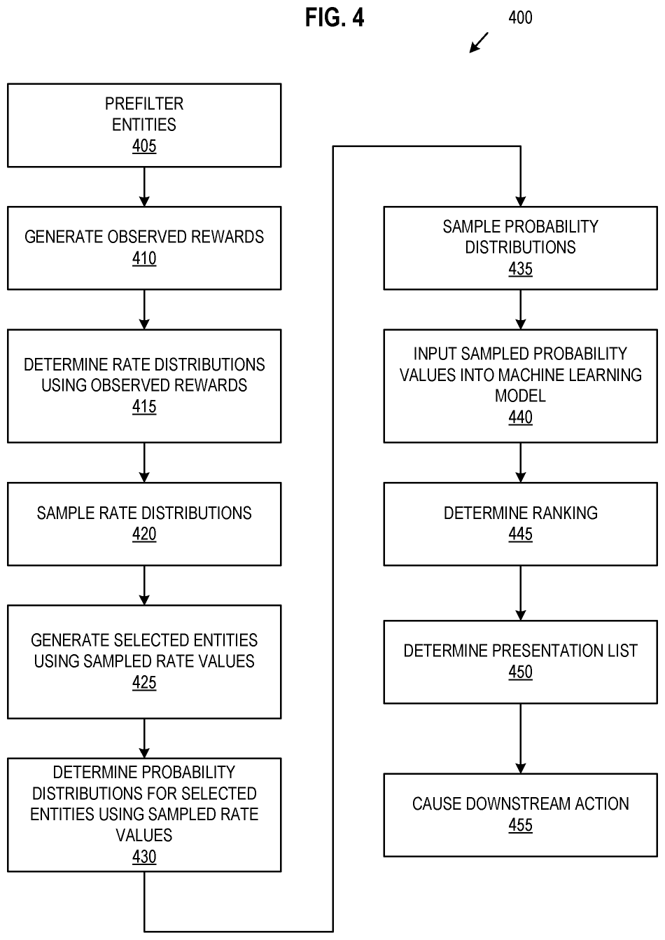

FIG. 4 is a flow diagram of an example method 400 to select and rank entities using distribution sampling, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by entity selection component 150 of FIG. 1. In other embodiments, the method 400 is performed by entity ranking component 160 of FIG. 1. In still other embodiments, different operations of method 400 are performed by entity selection component 150 while others are performed by entity ranking component 160. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 405, the processing device prefilters entities. For example, entity selection component 150 selects entities with follower numbers below a threshold value. For example, the processing device prefilters entities to select entities with fewer than 500 followers.

At operation 410, the processing device generates observed reward scores. For example, entity selection component 150 generates an observed reward score as a weighted combination of one or more of a follow score, a utility score, and a create score. The follow score indicates a probability that the user will follow the entity based on a user attribute. In some embodiments, follow score is an observed follow count of the entity for followers with the same user attribute. In some embodiments, the follow score is determined for a period of time. For example, the follow score is the number of users with the user attribute that have followed the entity within the past six months.

The utility score indicates a probability that the user will perform a downstream interaction after following the entity. In some embodiments, the utility score is an observed count of the number of post-follow responses relevant entity has received from users with the user attribute. In some embodiments, the utility score is determined for a period of time. For example, the utility score is the number of post-follow responses from users with the user attribute that the entity has received within the past six months.

The create score indicates the expected change in the content posted by the entity in response to post-follow responses by the user. In some embodiments, the create score is based on outputs of machine learning models using data from entities who have been followed by users with the user attribute, where the users then perform a downstream action.

At operation 415, the processing device determines rate distributions using observed reward scores and uncertainty. For example, entity selection component 150 generates a rate distribution using the weighted combination of follow, utility and create scores and the associated uncertainty. In some embodiments, the processing device uses the weighted combination of the follow, utility, and create scores as a mean value of the rate distribution and uses a number of selection times to determine the variance.

At operation 420, the processing device samples rate distributions. For example, entity selection component 150 samples the rate distributions to obtain a sampled rate value of a weighted combination of follow, utility, and create scores. The processing device generates the samples based on the rate distributions. In some embodiments, the rate distributions are gamma distributions.

At operation 425, the processing device generates selected entities using sampled rate values. For example, entity selection component 150 selects entities with sampled rate values that exceed a sample rate threshold. In some embodiments, entity selection component 150 selects a number of entities with the highest sampled rate values. For example, entity selection component selects a number of entities based on a number of presentation slots available in a user interface.

At operation 430, the processing device determines probability distributions for the selected entities using the sampled rate values. For example, entity ranking component 160 generates a probability distribution for the selected entities using the sampled rate values and a number of followers.

At operation 435, the processing device samples probability distributions. For example, entity ranking component 160 samples the probability distribution using Thompson sampling to obtain a sampled probability that predicts the weighted combination of follow, utility, and create scores. In some embodiments, the probability distributions are beta distributions, and the processing device uses a Thompson sampling method on the beta distributions to determine sampled probabilities.

At operation 440, the processing device inputs sampled probability values into machine learning model. For example, entity ranking component 160 sends the sampled probabilities to a model learning model to train the machine learning model to rank entities based on the sampled probabilities. In some embodiments, entity ranking component 160 sends the sampled probabilities to a trained machine learning ranking model in order to determine the ranking of the entities associated with the sampled probabilities.

At operation 445, the processing device determines ranking. For example, the trained machine learning model determines the ranking of entities associated with the sampled probabilities based on the sampled probabilities. The ranking of the entities is based on the sampled probabilities which predict the probability that the user will interact with the entities. In some embodiments, the ranking of the entities is based on the output of the ranking machine learning model.

At operation 450, the processing device determines presentation list. For example, the processing device determines which entities to present and in which order based on the ranking. In some embodiments, the processing device determines a number of entities to display based on the use case and displays the highest number using the ranking. In some embodiments, the presentation list is based on a presentation page of the application software system, such as application software system 130 of FIGS. 1 and 2. For example, presentation pages in the application software system may have different amounts of space allocated for presentation of entities. The number of entities able to be displayed will therefore vary, causing the size of the presentation list to also vary based on the presentation page.

At operation 455, the processing device causes a downstream action. For example, in some embodiments, the processing device causes the presentation list to be displayed to a user. In some embodiments, the processing device sends the presentation list to another component for further analysis or processing. In some embodiments, the processing device sends the presentation list to a component which reduces the number of entities to be selected. In some embodiments, the processing device sends the presentation list to another component which formats the presentation list for display and displays the presentation list to the user. In other embodiments, the processing device sends the presentation list to another component which uses the presentation list for internal processing and not for display.

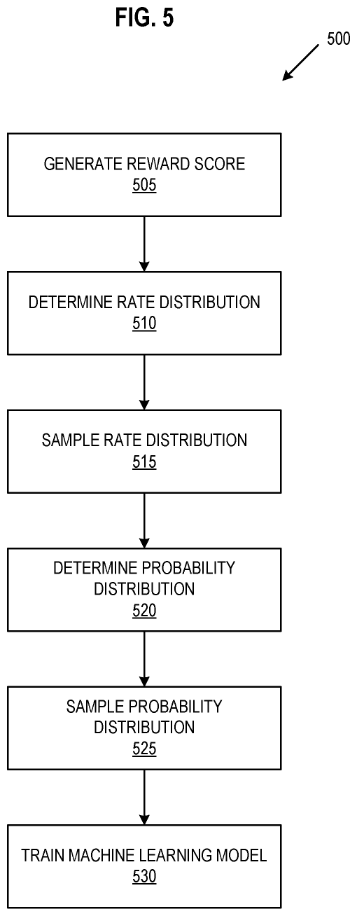

FIG. 5 is a flow diagram of an example method 500 to train a machine learning model to select and rank entities using distribution sampling, in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by entity selection component 150 of FIG. 1. In other embodiments, the method 500 is performed by entity ranking component 160 of FIG. 1. In still other embodiments, different operations of method 500 are performed by entity selection component 150 while others are performed by entity ranking component 160. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 505, the processing device generates a reward score. For example, entity selection component 150 generates a weighted combination of follow, utility, and create scores as described above with reference to FIG. 3. The follow score is an observed follow count of the entity for followers with the same user attribute. In some embodiments, the follow score is determined for a period of time. For example, the follow score is the number of users with the user attribute that have followed the entity within the past six months.

The utility score is an observed count of the number of post-follow responses relevant entity has received from users with the user attribute. In some embodiments, the utility score is determined for a period of time. For example, the utility score is the number of post-follow responses from users with the user attribute that the entity has received within the past six months.

The create score is based on outputs of machine learning models using data from entities who have been followed by users with the user attribute, where the users then perform a downstream action.

At operation 510, the processing device determines rate distributions. For example, entity selection component 150 generates a rate distribution using the weighted combination of follow, utility and create scores and the associated uncertainty. In some embodiments, the processing device uses the weighted combination of the uncertainty values as a mean value of the rate distribution and uses the uncertainty to determine the variance.

At operation 515, the processing device samples rate distributions. For example, entity selection component 150 samples the rate distributions to obtain a sampled rate value of a weighted combination of follow, utility, and create scores. The processing device generates the randomly samples based on the rate distributions. In some embodiments, the rate distributions are gamma distributions.

At operation 520, the processing device determines probability distributions. For example, entity ranking component 160 generates a probability distribution using the sampled rate values and a number of followers. In some embodiments, the processing device only determines probability distributions for sampled rates that satisfy a threshold value. For example, the processing device only generates probability distributions for sampled rates with a value exceeding a sample threshold. In other embodiments, the processing device only generates probability distributions for a predetermined number of the highest sampled rates.

At operation 525, the processing device samples probability distributions. For example, entity ranking component 160 samples the probability distribution using Thompson sampling to obtain a sampled probability that predicts the weighted combination of follow, utility, and create scores. In some embodiments, the probability distributions are beta distributions, and the processing device uses a Thompson sampling method on the beta distributions to determine sampled probabilities.

At operation 530, the processing device trains a machine learning model. For example, entity ranking component 160 sends the sampled probabilities to a model learning model to train the machine learning model to rank entities based on the sampled probabilities. In some embodiments, entity ranking component 160 sends the sampled probabilities to a trained machine learning ranking model in order to determine the ranking of the entities associated with the sampled probabilities.

FIG. 6 illustrates an example machine of a computer system 600 within which a set of instructions, for causing the machine to perform any one or more of the methodologies discussed herein, can be executed. In some embodiments, the computer system 600 can correspond to a component of a networked computer system (e.g., the computer system 100 of FIG. 1) that includes, is coupled to, or utilizes a machine to execute an operating system to perform operations corresponding to the entity selection component 150 and/or entity ranking component 160 of FIG. 1. The machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a smart phone, a tablet PC, a set-top box (STB), a Personal Digital Assistant (PDA), a cellular telephone, a web appliance, a server, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a memory 606 (e.g., flash memory, static random access memory (SRAM), etc.), an input/output system 610, and a data storage system 640, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 612 for performing the operations and steps discussed herein.

The computer system 600 can further include a network interface device 608 to communicate over the network 620. Network interface device 608 can provide a two-way data communication coupling to a network. For example, network interface device 608 can be an integrated-services digital network (ISDN) card, cable modem, satellite modem, or a modem to provide a data communication connection to a corresponding type of telephone line. As another example, network interface device 608 can be a local area network (LAN) card to provide a data communication connection to a compatible LAN. Wireless links can also be implemented. In any such implementation network interface device 608 can send and receive electrical, electromagnetic or optical signals that carry digital data streams representing various types of information.

The network link can provide data communication through at least one network to other data devices. For example, a network link can provide a connection to the world-wide packet data communication network commonly referred to as the “Internet,” for example through a local network to a host computer or to data equipment operated by an Internet Service Provider (ISP). Local networks and the Internet use electrical, electromagnetic or optical signals that carry digital data to and from computer system computer system 600.

Computer system 600 can send messages and receive data, including program code, through the network(s) and network interface device 608. In the Internet example, a server can transmit a requested code for an application program through the Internet and network interface device 608. The received code can be executed by processing device 602 as it is received, and/or stored in data storage system 640, or other non-volatile storage for later execution.

The input/output system 610 can include an output device, such as a display, for example a liquid crystal display (LCD) or a touchscreen display, for displaying information to a computer user, or a speaker, a haptic device, or another form of output device. The input/output system 610 can include an input device, for example, alphanumeric keys and other keys configured for communicating information and command selections to processing device 610. An input device can, alternatively or in addition, include a cursor control, such as a mouse, a trackball, or cursor direction keys for communicating direction information and command selections to processing device 610 and for controlling cursor movement on a display. An input device can, alternatively or in addition, include a microphone, a sensor, or an array of sensors, for communicating sensed information to processing device 610. Sensed information can include voice commands, audio signals, geographic location information, and/or digital imagery, for example.

The data storage system 640 can include a machine-readable storage medium 642 (also known as a computer-readable medium) on which is stored one or more sets of instructions 644 or software embodying any one or more of the methodologies or functions described herein. The instructions 644 can also reside, completely or at least partially, within the main memory 604 and/or within the processing device 602 during execution thereof by the computer system 600, the main memory 604 and the processing device 602 also constituting machine-readable storage media.

In one embodiment, the instructions 626 include instructions to implement functionality corresponding to an entity selection component 150 and/or entity ranking component (e.g., the entity selection component 150 and/or entity ranking component 160 of FIG. 1). While the machine-readable storage medium 642 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the computing system 100, can carry out the computer-implemented methods 400 and 500 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

Illustrative examples of the technologies disclosed herein are provided below. An embodiment of the technologies may include any of the examples or a combination of the described below.

An example 1 includes generating a reward score for an entity, determining a rate distribution using the reward score and a number of times the entity has been selected for ranking, generating a sampled rate value by sampling the rate distribution, generating a probability score for a pair of the entity and a user based on the sampled rate value, determining a probability distribution using the probability score, generating a sampled probability value by sampling the probability distribution, and training a machine learning model using the sampled probability value.

An example 2 includes the subject matter of example 1, further including determining observed rewards for the entity and generating the reward score using the observed rewards. An example 3 includes the subject matter of any of examples 1 and 2, further including receiving a master set of entities, where a master entity of the master set of entities has a number of followers and generating the plurality of entities by filtering the master set of entities based on the number of followers. An example 4 includes the subject matter of any of examples 1-3, further including generating the reward score for the entity and an attribute of a plurality of attributes by generating an attribute reward score for the entity based on the attribute, where the attribute reward score includes at least one of a follow score, a utility score, or a create score, and determining the rate distribution for the entity by determining the rate distribution for the entity using the attribute reward score and the number of times the entity has been selected for ranking. An example 5 includes the subject matter of example 4, where generating the reward score for the entity further includes determining the attribute of the plurality of attributes, where the attribute includes at least one of: entity, title location, industry, or skills.

An example 6 includes generating a reward score for an entity of a plurality of entities, where the reward score includes at least one of a follow score, a utility score, or a create score, determining a rate distribution for the entity using the reward score, generating a sampled rate value for the entity by sampling the rate distribution, and training the machine learning model to rank the plurality of entities using the sampled rate value.

An example 7 includes the subject matter of example 6, further including determining observed rewards for the entity and generating the reward score using the observed rewards. An example 8 includes the subject matter of any of examples 6 and 7, further including receiving a master set of entities, where a master entity of the master set of entities has a number of followers and generating the entities by filtering the master set of entities based on the number of followers. An example 9 includes the subject matter of any of examples 6-8, further including generating the reward score for the entity and an attribute by generating an attribute reward score, where the attribute reward score includes at least one of a follow score, a utility score, or a create score, and determining the rate distribution for the entity and the attribute by determining the rate distribution for the entity and the attribute using the attribute reward score and a number of times the entity has been selected for ranking. An example 10 includes the subject matter of example 9, where generating the reward score for the entity further includes determining the attribute, where the attribute includes at least one of: entity, title location, industry, or skills.

An example 11 includes a system for training a machine learning model to rank including at least one memory device and a processing device operatively coupled with the at least one memory device, to generate a reward score for an entity, determine a rate distribution using the reward score, and a number of times the entity has been selected for ranking, generate a sampled rate value by sampling the rate distribution, generate a probability score for a pair of the entity and a user based on the sampled rate value, determine a probability distribution using the probability score, generate a sampled probability value by sampling the probability distribution, and train a machine learning model using the sampled probability value.

An example 12 includes the subject matter of example 11, where the processing device is further to determine observed rewards for the entity and generate the reward score using the observed rewards. An example 13 includes the subject matter of any of examples 11 and 12, where the processing device is further to receive a master set of entities, where a master entity of the master set of entities has a number of followers and generate the entities by filtering the master set of entities based on the number of followers. An example 14 includes the subject matter of any of examples 11-13, where the processing device is further to generate the reward score for the entity and an attribute by generating an attribute reward score for the entity based on the attribute, where the attribute reward score includes at least one of a follow score, a utility score, or a create score, and determine the rate distribution for the entity by determining the rate distribution for the entity using the attribute reward score and the number of times the entity has been selected for ranking. An example 15 includes the subject matter of example 14, where the processing device is further to determine the attribute, where the attribute includes at least one of: entity, title location, industry, or skills.

An example 16 includes a system for training a machine learning model to rank including at least one memory device and a processing device operatively coupled with the at least one memory device, to generate a reward score for an entity, where the reward score includes at least one of a follow score, a utility score, or a create score, determine a rate distribution for the entity using the reward score, generate a sampled rate value for the entity by sampling the rate distribution, and train the machine learning model to rank the plurality of entities using the sampled rate value.

An example 17 includes the subject matter of example 16, where the processing device is further to determine observed rewards for the entity and generate the reward score using the observed rewards. An example 18 includes the subject matter of any of examples 16 and 17, where the processing device is further to receive a master set of entities, where a master entity of the master set of entities has a number of followers and generate the entities by filtering the master set of entities based on the number of followers. An example 19 includes the subject matter of any of examples 16-18, where the processing device is further to generate the reward score for the entity and an attribute by generating an attribute reward score, where the attribute reward score includes at least one of a follow score, a utility score, or a create score, and determine the rate distribution for the entity by determining the rate distribution for the entity and the attribute using the attribute reward score and the number of times the entity has been selected for ranking. An example 20 includes the subject matter of example 19, where the processing device is further to determine the attribute, where the attribute includes at least one of: entity, title location, industry, or skills.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method for training a machine learning model for ranking, the method comprising:
generating a reward score for an entity of a plurality of entities;
determining a rate distribution for the entity using the reward score and a number of times the entity has been selected for ranking;
generating a sampled rate value for the entity by sampling the rate distribution;
generating a probability score for a pair of the entity and a user based on the sampled rate value;
determining a probability distribution for the pair using the probability score;
generating a sampled probability value for the pair by sampling the probability distribution; and
training the machine learning model to rank the plurality of entities using the sampled probability value.

2. The method of claim 1, further comprising:
determining observed rewards for the entity; and
generating the reward score using the observed rewards.

3. The method of claim 1, further comprising:
receiving a master set of entities, wherein a master entity of the master set of entities has a number of followers; and
generating the plurality of entities by filtering the master set of entities based on the number of followers.

4. The method of claim 1, further comprising:
generating the reward score for the entity and an attribute of a plurality of attributes by:
generating an attribute reward score for the entity based on the attribute, wherein the attribute reward score comprises at least one of a follow score, a utility score, or a create score; and
determining the rate distribution for the entity by:
determining the rate distribution for the entity using the attribute reward score and the number of times the entity has been selected for ranking.

5. The method of claim 4, wherein generating the reward score for the entity further comprises:
determining the attribute of the plurality of attributes, wherein the attribute comprises at least one of: entity, title location, industry, or skills.

6. A method for training a machine learning model for ranking comprising:
generating a reward score for an entity of a plurality of entities, wherein the reward score comprises at least one of a follow score, a utility score, or a create score;
determining a rate distribution for the entity using the reward score;
generating a sampled rate value for the entity by sampling the rate distribution; and
training the machine learning model to rank the plurality of entities using the sampled rate value.

7. The method of claim 6, further comprising:
determining observed rewards for the entity; and
generating the reward score using the observed rewards.

8. The method of claim 6, further comprising:
receiving a master set of entities, wherein a master entity of the master set of entities has a number of followers; and
generating the plurality of entities by filtering the master set of entities based on the number of followers.

9. The method of claim 6, further comprising:
generating the reward score for the entity and an attribute of a plurality of attributes by:
generating an attribute reward score for the attribute, wherein the attribute reward score comprises at least one of a follow score, a utility score, or a create score; and
determining the rate distribution for the entity and the attribute by:
determining the rate distribution for the entity and the attribute using the attribute reward score and a number of times the entity has been selected for ranking.

10. The method of claim 9, wherein generating the reward score for the entity further comprises:
determining the attribute of the plurality of attributes, wherein the attribute comprises at least one of: entity, title location, industry, or skills.

11. A system for training a machine learning model to rank, the system comprising:
at least one memory device; and
a processing device, operatively coupled with the at least one memory device, to:
generate a reward score for an entity of a plurality of entities;
determine a rate distribution for the entity using the reward score and a number of times the entity has been selected for ranking;
generate a sampled rate value for the entity by sampling the rate distribution;
generate a probability score for a pair of the entity and a user based on the sampled rate value;
determine a probability distribution for the pair using the probability score;
generate a sampled probability value for the pair by sampling the probability distribution; and
train the machine learning model to rank the plurality of entities using the sampled probability value.

12. The system of claim 11, wherein the processing device is further to:
determine observed rewards for the entity; and
generate the reward score using the observed rewards.

13. The system of claim 11, wherein the processing device is further to:
receive a master set of entities, wherein a master entity of the master set of entities has a number of followers; and
generate the plurality of entities by filtering the master set of entities based on the number of followers.

14. The system of claim 11, wherein the processing device is further to:
generate the reward score for the entity and an attribute of a plurality of attributes by:
generating an attribute reward score for the entity based on the attribute, wherein the attribute reward score comprises at least one of a follow score, a utility score, or a create score; and
determine the rate distribution for the entity by:
determining the rate distribution for the entity using the attribute reward score and the number of times the entity has been selected for ranking.

15. The system of claim 14, wherein the processing device is further to:
determine the attribute of the plurality of attributes, wherein the attribute comprises at least one of: entity, title location, industry, or skills.

16. A system for training a machine learning model for ranking comprising:
at least one memory device; and
a processing device, operatively coupled with the at least one memory device, to:
generate a reward score for an entity of a plurality of entities, wherein the reward score comprises at least one of a follow score, a utility score, or a create score;
determine a rate distribution for the entity using the reward score;
generate a sampled rate value for the entity by sampling the rate distribution; and
train the machine learning model to rank the plurality of entities using the sampled rate value.

17. The system of claim 16, wherein the processing device is further to:
determine observed rewards for the entity; and
generate the reward score using the observed rewards.

18. The system of claim 16, wherein the processing device is further to:
receive a master set of entities, wherein a master entity of the master set of entities has a number of followers; and
generate the plurality of entities by filtering the master set of entities based on the number of followers.

19. The system of claim 16, wherein the processing device is further to:
generate the reward score for the entity and an attribute of a plurality of attributes by:
generating an attribute reward score for the attribute, wherein the attribute reward score comprises at least one of a follow score, a utility score, or a create score; and
determine the rate distribution for the entity by:
determining the rate distribution for the entity and the attribute using the attribute reward score and a number of times the entity has been selected for ranking.

20. The system of claim 19, wherein the processing device is further to:
determine the attribute of the plurality of attributes, wherein the attribute comprises at least one of: entity, title location, industry, or skills.
